(19) United States
(12) Patent Application Publication
(10) Pub. No.: US 2018/0356029 A1
(43) Pub. Date: Dec. 13, 2018

(54) Hanger Assembly

(71) Applicant: WELLSCO INTERNATIONAL GROUP CO., LTD, HangZhou (CN)

(72) Inventor: Shih-Hao Fang, Taipei City (TW)

(73) Assignee: WELLSCO INTERNATIONAL GROUP CO., LTD, HangZhou (CN)

(21) Appl. No.: 15/621,751

(22) Filed: Jun. 13, 2017

(51) Int. Cl. F16M 13/02

(52) U.S. Cl. CPC F16M 13/02

(57) ABSTRACT

A hanger assembly has a fixing board and a hanging ring. The fixing board has a metal body and a plastic holder. The metal body has at least one through hole defined through the metal body. The plastic holder is disposed on the metal body and has at least one through hole corresponding in position respectively to the at least one through hole in the metal body. The hanging ring is swingingably connected with the fixing board.

### BACKGROUND OF THE INVENTION

### I. Field of the Invention

The present invention relates to a hanger assembly, and more particularly to a hanger assembly that can prevent a fastener from escaping from the hanger assembly.

### 2. Description of Related Art

A conventional hanger is attached to a flat object, such as a wall or a cabinet, for hanging objects. In practice, at least one fastener is usually held in advance in a through hole/through holes in a body of the hanger, such that a user can securely attach the hanger onto the flat object conveniently. However, because the conventional hanger is made of metal, the fasteners cannot be held in the through holes firmly. Therefore, the fasteners easily escape from the through holes, and the hanger cannot be attached to the flat object without the fasteners.

To overcome the shortcomings, the present invention tends to provide a hanger assembly to mitigate or obviate the aforementioned problems.

### SUMMARY OF THE INVENTION

The main Objective of the invention is to provide a hanger assembly at can prevent a fastener from escaping from the hanger assembly.

The hanger assembly has a fixing board and a hanging ring. The fixing board has a metal body and a plastic holder. The metal body has at least one through hole defined through the metal body. The plastic holder is disposed on the metal body and has at least one through hole corresponding in position respectively to the at least one through hole in the metal body. The hanging ring is swingingably connected with the fixing board.

Other objects, advantages and novel features of the invention will become more apparent from the following detailed description when taken in conjunction with the accompanying drawings.

### BRIEF DESCRIPTION OF′ THE DRAWINGS

FIG. 1 is a perspective view of a first embodiment of a hanger assembly in accordance with the present invention;

FIG. 2 is a perspective view in partial section of the hanger assembly in FIG. 1;

FIG. 3 is an enlarged side view in partial section of the hanger assembly in FIG. 1;

FIG. 4 is a perspective view of a second embodiment of a hanger assembly in accordance with the present invention;

FIG. 5 is a perspective view in partial section of the hanger assembly in FIG. 4;

FIG. 6 is an enlarged side view in partial section of the hanger assembly in FIG. 4;

FIG. 7 is a perspective view of a third embodiment of a hanger assembly in accordance with the present invention;

FIG. 8 is a perspective view in partial section of the hanger assembly in FIG. 7;

FIG. 9 is an enlarged side view in partial section of the hanger assembly in FIG. 7;

FIG. 10 is a perspective view of a fourth embodiment of a hanger assembly in accordance with the present invention;

FIG. 11 is a perspective view in partial section of the hanger assembly in FIG. 10; and

FIG. 12 is an enlarged side view in partial section of the hanger assembly in FIG. 10.

### DETAILED DESCRIPTION OF PREFERRED EMBODIMENT

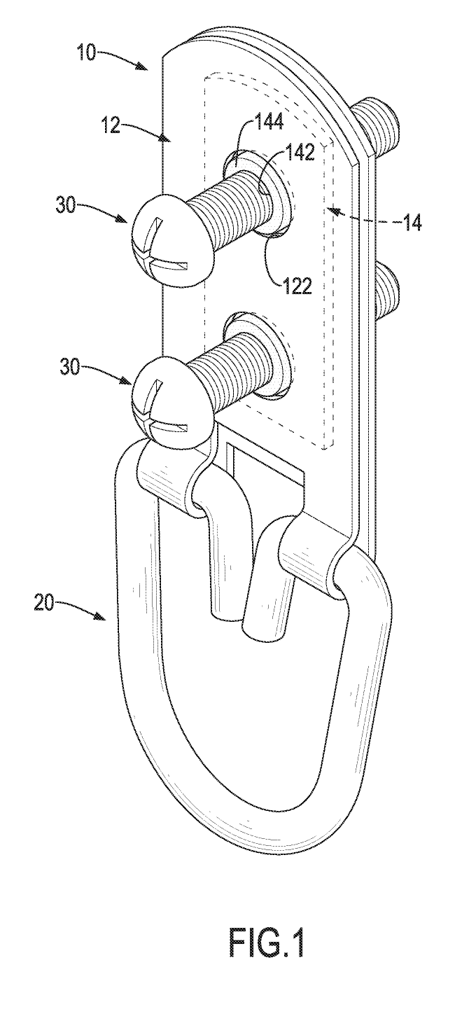

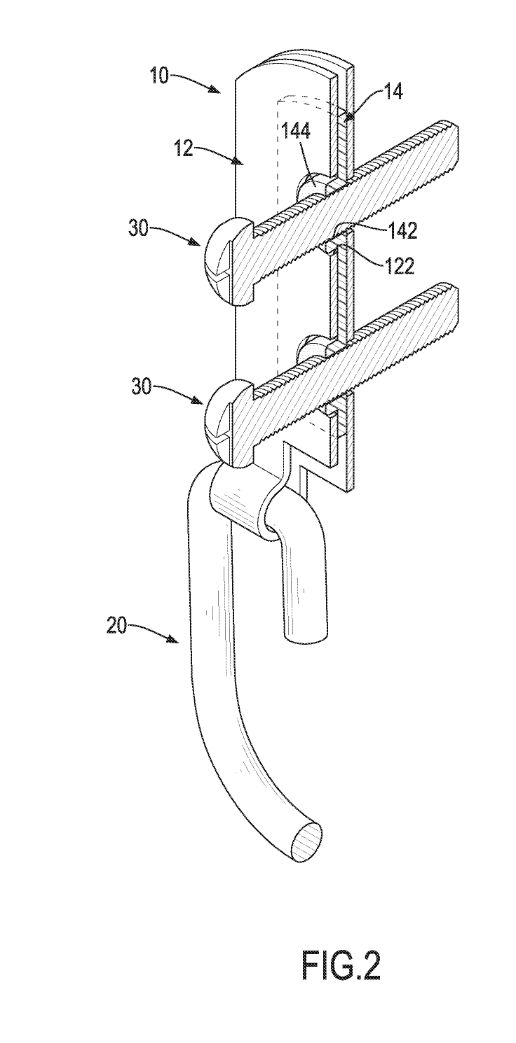

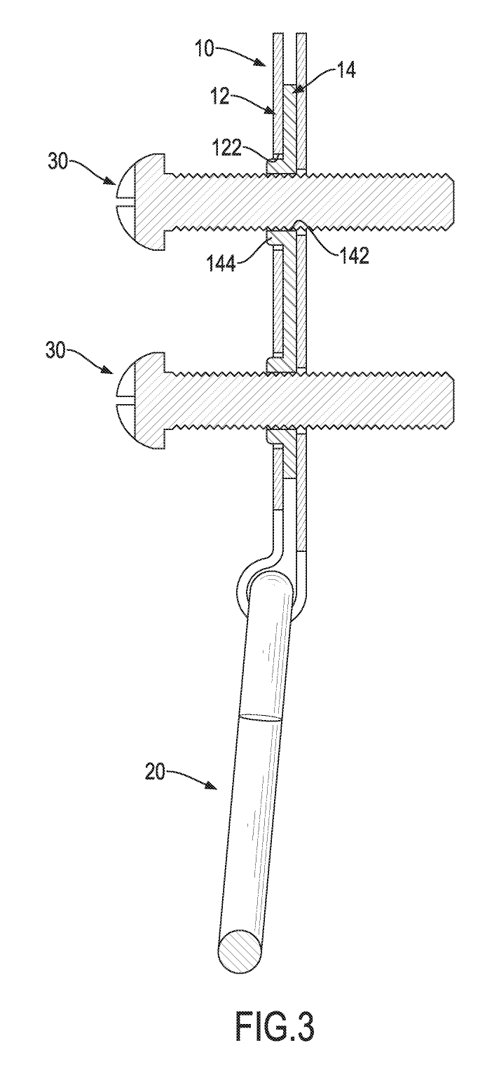

With reference to FIGS. 1 to 3, a first embodiment of a hanger assembly in accordance with the present invention comprises a fixing board 10 and a hanging ring 20.

The fixing board 10 comprises a metal body 12 and a plastic holder 14. The metal body 12 is formed by bending a metal sheet to make the metal body 12 have a U-shaped cross section. The metal body 12 has at least one through hole 122 defined through the metal body 12. In the first embodiment, two through holes 12 are implemented.

The plastic holder 14 is disposed on the metal body 12 and has at least one through hole 142 defined through the plastic holder 14 and corresponding in position respectively to the at least one through hole 122 in the metal body 12. In the first embodiment, the plastic holder 14 is clamped between two sides of the metal body 12, and two through holes 142 are implemented. Two protrusions 144 are formed on and protrude from the plastic holder 14 and extend respectively into the two through holes 122 in the metal body 12. The two through holes 142 are formed respectively through the two protrusions 144.

The hanging ring 20 is connected with the fixing board 10 and is applied to hang an object on the hanging ring 20. In the first embodiment, the hanging ring 20 is swingingably connected with a bent segment of the metal body 12.

With such an arrangement, two fasteners 30 inserted respectively into the two through holes 142 in the plastic holder 14 can be firmly held in the two through holes 142. Accordingly, the fasteners 30 can be kept from escaping from the through holes 142 in the plastic holder 14, and the hanger assembly can be securely attached onto a flat object conveniently. In addition, the through holes 142 of the plastic holder 14 can provide a guiding effect to the fasteners 30 to prevent the fasteners 30 from being inclined during the process of attaching the hanger assembly onto a flat object.

In addition, because the fasteners 30 are mounted around by the protrusions 144 of the plastic holder 14, the fastener 30 can be kept from contacting the metal body 12. Accordingly, the metal body 12 can be prevented from being damaged by the fasteners 30.

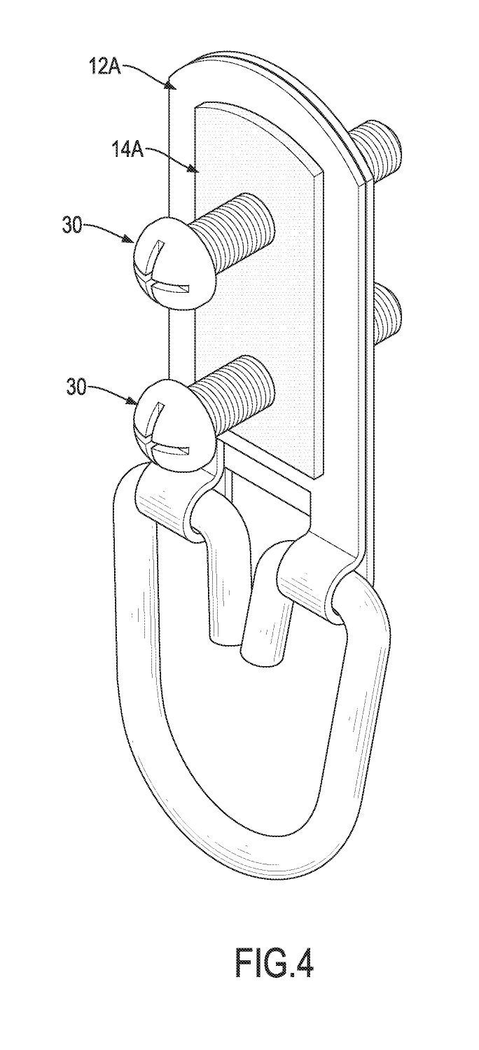

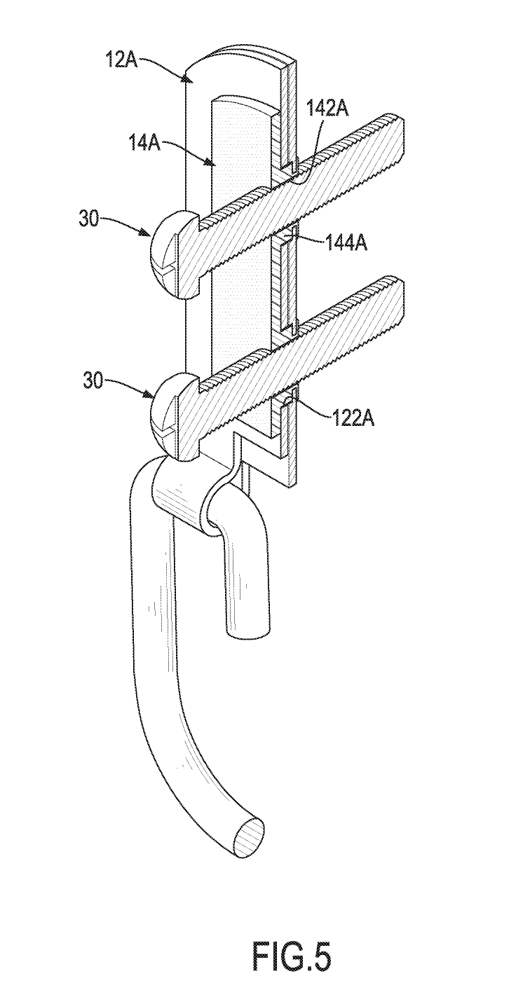

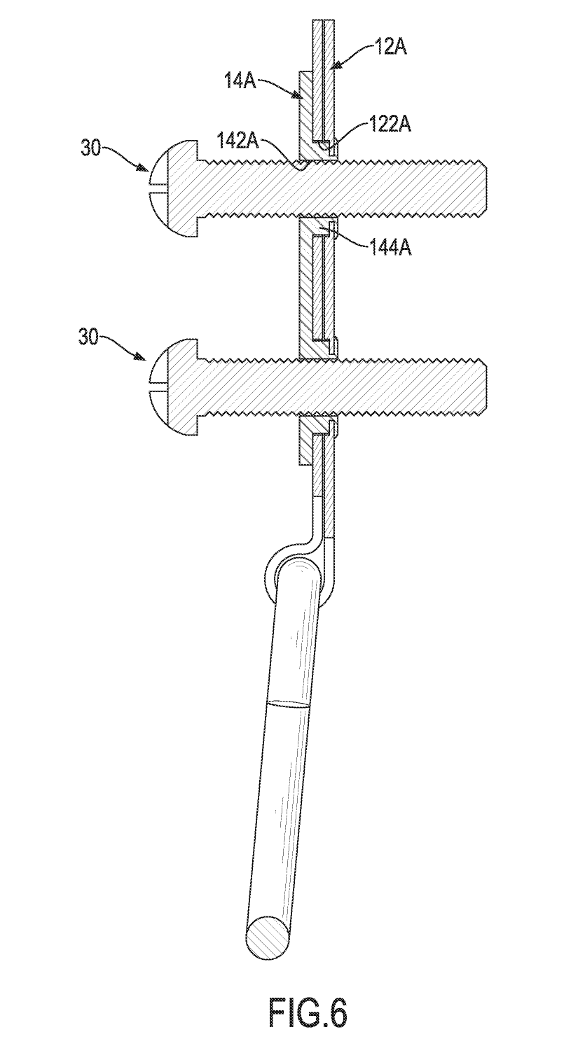

With reference to FIGS. 4 to 6, in a second embodiment, the plastic holder 14A is rectangular in shape and is attached to a front side of the metal body 12A. Two protrusions 144A are formed on and protrude from a rear side of the plastic holder 14A and extend respectively into the through holes 122A in the metal body 12A. Two through holes 142A are respectively formed through the two protrusions 144A.

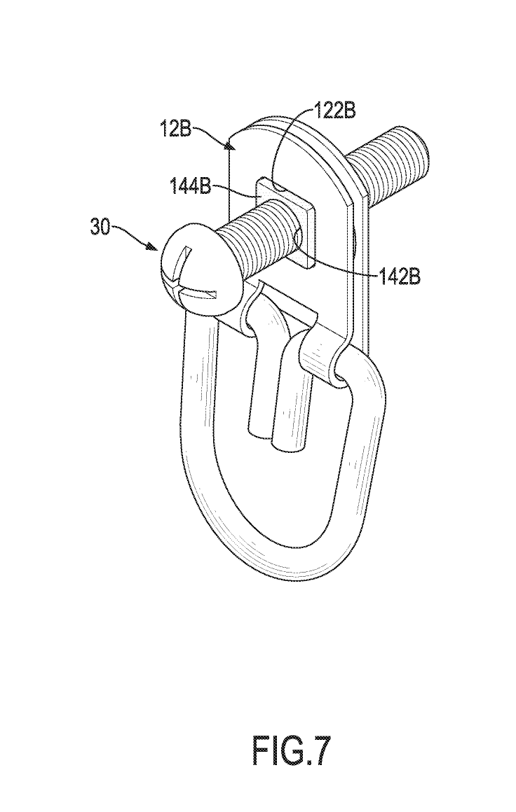

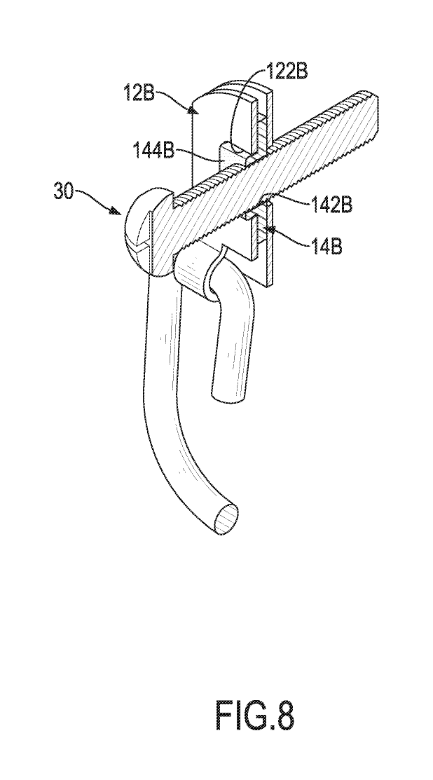

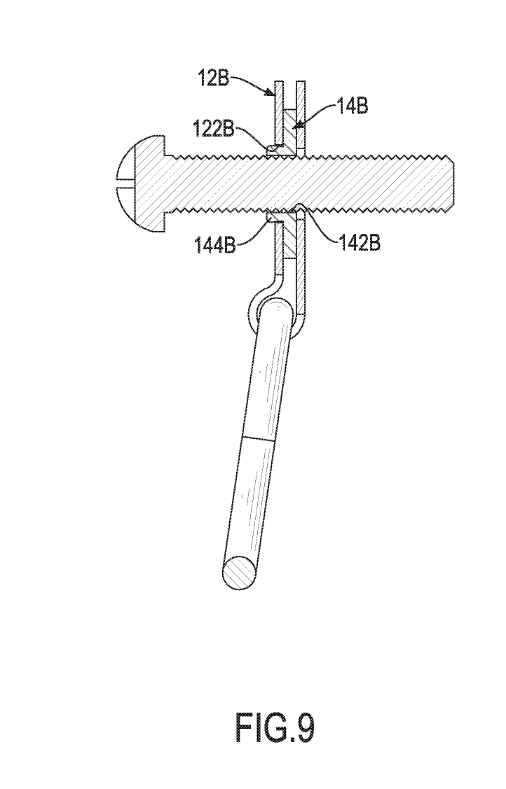

With reference to FIGS. 7 to 9, in the third embodiment, the hanger assembly in the third embodiment has a structure similar to that in the first embodiment except that one through hole 122B, 142B is implemented in each one of the metal body 12B and the plastic holder 14B, and one protrusion 144B is formed on the plastic holder 14B.

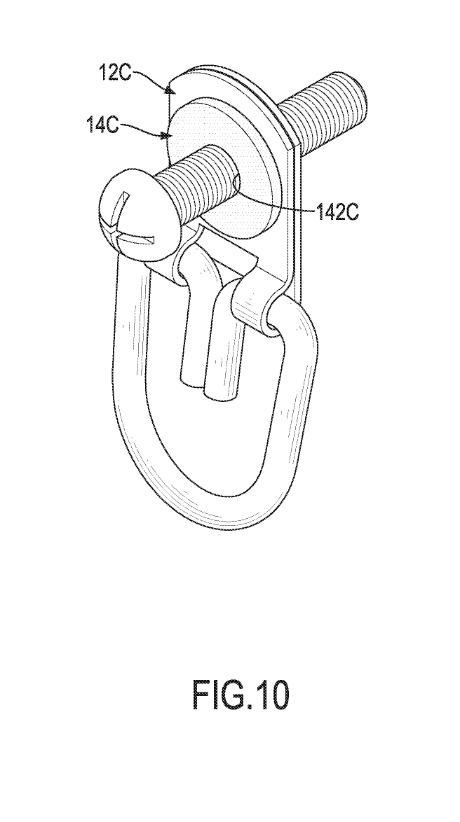

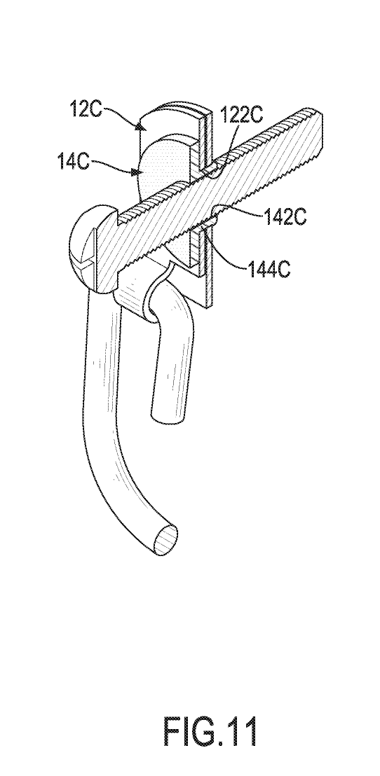

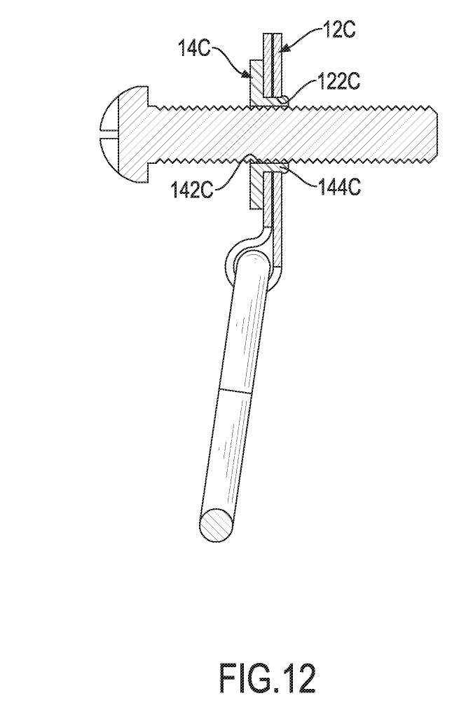

With reference to FIGS. 10 to 12, in the fourth embodiment, the hanger assembly in the fourth embodiment has a structure similar to that in the second embodiment except that one through hole 1220, 142C is implemented in each one of the metal body 12C and the plastic holder 14C, and one protrusion 144C is formed on the plastic holder 14C. The plastic holder 14C is circular in shape.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1: A hanger assembly comprising:
a fixing board comprising
a metal body having at least one through hole defined through the metal body; and
a plastic holder disposed on the metal body and having at least one through hole corresponding in position respectively to the at least one through hole in the metal body;
a hanging ring swingingably connected with the fixing board; and
at least one fastener respectively inserted into and firmly held in the at least one through hole in the plastic holder.

2: The hanger assembly as claimed in claim 1, wherein
the metal body is formed by bending a metal sheet to make the metal body have a U-shaped cross section; and
the plastic holder is clamped between two sides of the metal body.

3: The hanger assembly as claimed in claim 2, wherein the plastic holder has at least one protrusion formed on and protruding from the plastic holder and extending respectively into the at least one through hole in the metal body.

4: The hanger assembly as claimed in claim 3, wherein
the at least one through hole of the metal body comprises two through holes;
the at least one through hole of the plastic holder comprises two through holes; and
the at least one protrusion of the plastic holder comprises two protrusions.

5: The hanger assembly as claimed in claim 3, wherein
the at least one through hole of the metal body comprises one through hole;
the at least one through hole of the plastic holder comprises one through hole; and
the at least one protrusion of the plastic holder comprises one protrusion.

6: The hanger assembly as claimed in claim 1, wherein
the metal body is formed by bending a metal sheet to make the metal body have a U-shaped cross section; and
the plastic holder is attached to a front side of the metal body.

7: The hanger assembly as claimed in claim 6, wherein the plastic holder has at least one protrusion formed on and protruding from a rear side of the plastic holder and extending respectively into the at least one through hole in the metal body.

8: The hanger assembly as claimed in claim 7, wherein
the at least one through hole of the metal body comprises two through holes;
the at least one through hole of the plastic holder comprises two through holes; and
the at least one protrusion of the plastic holder comprises two protrusions.

9: The hanger assembly as claimed in claim 7, wherein
the at least one through hole of the metal body comprises one through hole;
the at least one through hole of the plastic holder comprises one through hole; and
the at least one protrusion of the plastic holder comprises one protrusion.
